(19) United States
(12) Patent Application Publication
(10) Pub. No.: US 2004/0149238 A1
(43) Pub. Date: Aug. 5, 2004

(54) System and method to inform of optimal pet brushing criteria and packaging using the same

(76) Inventors: Stephanie K. Schneider, Medina, OH (US); Tracie Ho-Fatt, Unionville (CA)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/726,057

(22) Filed: Dec. 2, 2003

Related U.S. Application Data
(60) Provisional application No. 60/430,109, filed on Dec. 2, 2002.

(51) Int. Cl. A01K 13/00

(52) U.S. Cl. 119/601

(57) ABSTRACT

A system, method, and packaging for informing users of correct pet brushing criteria for their pets include providing a package identifying at least one example of a pet coat type and showing an assigned identifier on the package for that pet coat type. The method further includes providing at least one pet grooming tool on the package that corresponds with the identifier and the pet coat type. The method and system include providing a plurality of different such packages for different grooming tools and displaying same. A user can identify the pet coat type for their pet and then select the proper grooming tool based on the markings of the package.

### RELATED APPLICATION DATA

The present application is a non-provisional application based on, and claiming the priority benefit of, co-pending U.S. provisional application Serial No. 60/430,109, which was filed on Dec. 2, 2002, and is expressly incorporated by reference herein.

### FIELD OF THE DISCLOSURE

The present invention generally relates to pet care products and, more particularly, to a system and method of informing a user of optimal pet brushing criteria and packaging using the same.

### BACKGROUND OF THE DISCLOSURE

Pet grooming tools, such as slicker brushes, pin brushes, combs, short bristle brushes, shedding blades, rakes, and dematting brushes are known in the art. Shedding, however, is still one of the top frustrations of pet owners, even though all these tools are available for their use. Shedding causes pet hair to be scattered all over the house, including on furniture, rugs, clothing, bedding etc., and causes the pet owners to constantly clean and sweep their homes. Many pet owners believe that if they were to brush and groom their pet more often there may be less shedding in the house. However, the current experience of brushing a pet is difficult. Many pets do not like to be brushed and run away, making it difficult, if not impossible, for the owners to brush/comb their pets.

Through research, including interviews and consumer observations, it has been determined that many owners are not aware of and are not using the “tools” optimal for their pet's coat. It has also been determined that the owners, when using the proper tool, do not know the optimal way to use the tool in grooming their pet's coat.

Past solutions consist of packaging that identifies pet size, bristle type on the brushes, and basic features and benefits of the product. Such solutions have resulted in pet owners owning pet grooming tools that are not suited for their pet's coat type, and/or not knowing how to properly use the pet grooming tools they own. Furthermore, past solutions have only shown one or two illustrations/photographs of randomly chosen model pets that have no link to the functionality of the product to help remove hair and reduce shedding for a particular pet owner's pet.

### SUMMARY OF THE DISCLOSURE

In accordance with one aspect of the disclosure, a method of informing of pet brushing criteria is disclosed. The method includes providing at least one example of a pet coat type and assigning an identifier to that pet coat type. The method further includes coding an object with the identifier and providing at least one pet grooming tool on the object that corresponds to the identifier.

In accordance with another aspect of the disclosure, a package having information relating to pet brushing criteria is disclosed. The package includes a body having a front side, a rear side, a top and a bottom. The package further includes a first display corresponding to at least one example of a pet coat type and an identifier that corresponds to the pet coat type. Accompanying the package is a pet grooming tool.

In accordance with another aspect of the disclosure, a method of informing of pet brushing criteria on a package is disclosed. The method includes providing at least one example of a pet coat type on the package and assigning an identifier to the pet coat type. The method further includes coding the package with the identifier and providing at least one pet grooming tool with the package that correspond to the identifier.

In accordance with another aspect of the disclosure, a chart having information relating to pet brushing criteria is disclosed. The chart includes a plurality of pet coat types, and at least one example of breed that corresponds to each of the pet coat types. The chart further includes an identifier that corresponds to each of the pet coat types, and at least one example of a pet grooming tool that correspond to each identifier.

### BRIEF DESCRIPTION OF THE DRAWINGS

FIG. 1 is a front isometric view of a product packaging and a pet grooming tool in accordance with the teachings of the present disclosure;

FIG. 1a is a front isometric view of another product packaging and a pet grooming tool;

FIG. 2 is a rear isometric view of the product packaging and a pet grooming tool of FIG. 1;

FIG. 2a is a rear isometric view of the product packaging and a pet grooming tool of FIG. 1a;

FIG. 3 is a front plan view of a plurality of product packaging and pet grooming tools;

FIG. 4 is a front plan view of chart arranging pet grooming tools according to pet coat type and breed; and

FIG. 5 is a front view of a display rack including a plurality of product packages of FIG. 1.

### DETAILED DESCRIPTION

The methods, systems, and packaging forms for informing of optimal pet brushing criteria as disclosed herein are intended to aid the user or owner of a pet in choosing and using the proper tool(s) for their pet's type of coat. The various types of coats that different breeds and different animals have may be categorized into types. These categories include, but are not limited to, short single coats, long single coats, short double coats, long double coats, and cat coats. The various types of tools that may be used to properly groom animals with these types of coats, include but are not limited to, slicker brushes, pin brushes, combs, short bristle brushes, shedding blades, rakes, and dematting brushes. Furthermore, the tools may vary depending on the type of pet coat for which it is designed. For example, a slicker brush designed for an animal having a short single coat may differ from a slicker brush designed for an animal having a long double coat. The present disclosure is directed to providing packaging, systems, and methods that organize and coordinate the variables and aid pet owners in identifying, selecting, and using pet care products.

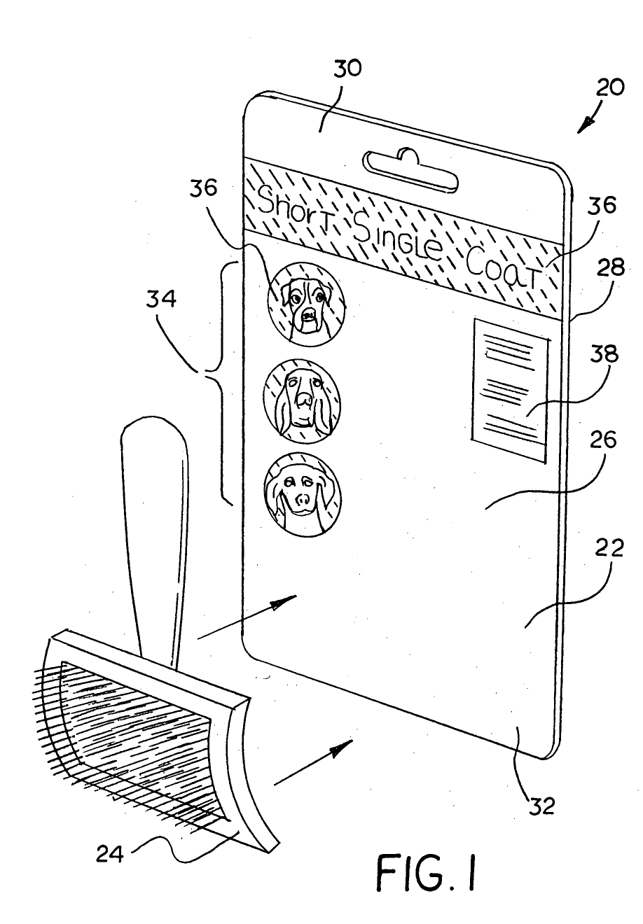

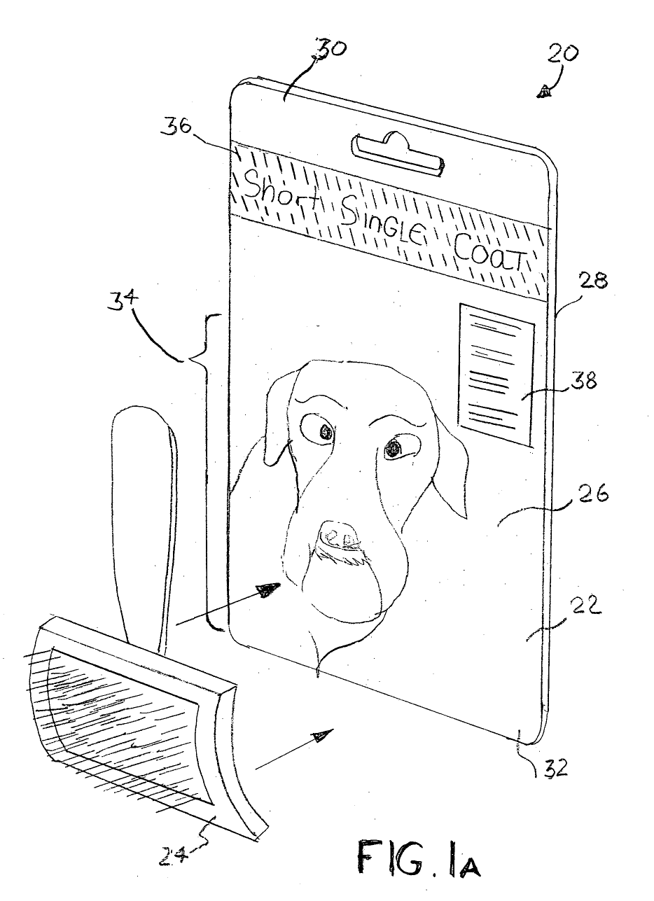

Referring now to the drawings, and with specific reference initially to FIG. 1, a package 20 includes a body 22 and a grooming tool 24. The body 22 includes a front surface 26, a rear surface 28, a top side 30, and a bottom side 32. The grooming tool 24 may be any of the grooming tools mentioned above, or other forms. In this exemplary embodiment, however, the grooming tool 24, as depicted, is a slicker brush.

The body 22 may further include one or more coat examples 34 of the pet coat type, and more specifically, may include a coat example 34 on the front surface 26 of the body 22. The one or more coat examples 34 are, however, not limited to the front surface 26 of the package, but may be disposed on the rear surface 28, or both the front and rear surfaces 26, 28 of the package 20. The coat example 34 of the pet coat type, as seen in FIG. 1, may be one or more pictures or photographs of breeds having that particular type of coat, or may be the names of one or more breeds having that particular type of coat. In this exemplary embodiment, the coat example 34 of the pet coat type includes a picture of a Boxer, a Beagle, and a Weimaraner. In another exemplary embodiment, as seen in FIG. 1a the coat example 34 of the pet coat type includes a picture of a Boxer, much larger than the pictures in FIG. 1.

The name of the type of pet coat, as seen in FIG. 1, may also be present on the body 22 of the package 20, and more particularly, may be present on the front surface 26 of the body 22. However, the name of the pet coat type can also be placed alternatively on the rear surface 28 or on both surfaces. The names of the different types of pet coats, as identified above, may include but are not limited to, short single coat, long single coat, short double coat, long double coat, long silky coat, all coats and cat coat. Additionally, cat coats may be categorize into separate categories and may be identified as such if desired. In this exemplary embodiment, the name of the pet coat type for a boxer, as an example, is short single coat.

An identifier 36, identifying the type of pet coat, as seen in FIG. 1, may also be present on the body 22 of the package 20, and more particularly, may be present on the front surface 26 of the body 22. The identifier 36 is, however, not limited to being displayed on the front surface 26 of the package, but may be disposed on the rear surface 28, or both the front and rear surfaces 26, 28 of the package 20. The identifier 36 may be any visible indicia that identifies or is representative of a corresponding type of pet coat. In this exemplary embodiment, the identifier 36 for a short single coat is the color green. As such, each pet coat type is assigned a color and that color may appear on the body 22. In this exemplary embodiment, the identifier 36 may appear as a colored bar running across the front surface 26 of the body 22, and/or may be a colored background in the coat example 34 of the pet coat type. For example, the identifier 36 for a short double coat may be gold, and for a long single coat may be blue. The identifiers 36, need not be colors, but may be for example, symbols, signs, numbers, letters, a combination thereof, or any other visual indicia useful to identify pet coat types for a user that relate to the grooming tool of the package.

A benefit display 38, explaining or obviating the benefits of the particular grooming tool, may also be present on the body 22 of the package 20, and more particularly, may be present on the front surface 26 of the body 22. Again, the benefit display may alternatively be shown on the rear surface 28 or on both surfaces if desired. The benefit display 38 may be written text explaining the benefits of the particular grooming tool 24, may be a diagram or drawing showing the benefits of the particular grooming tool 24, or may be a combination thereof. In this exemplary embodiment, the benefit display 38 is written text explaining the benefits of the slicker brush.

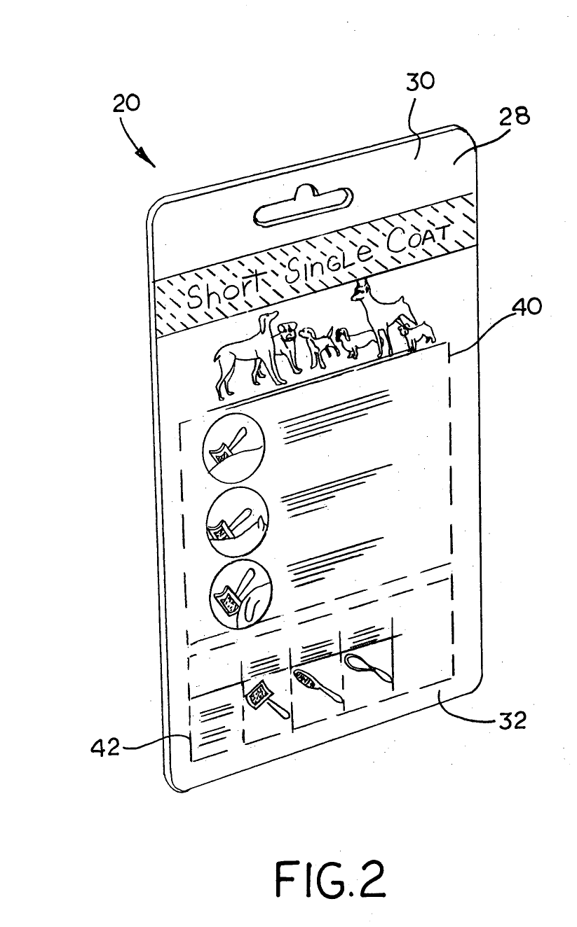

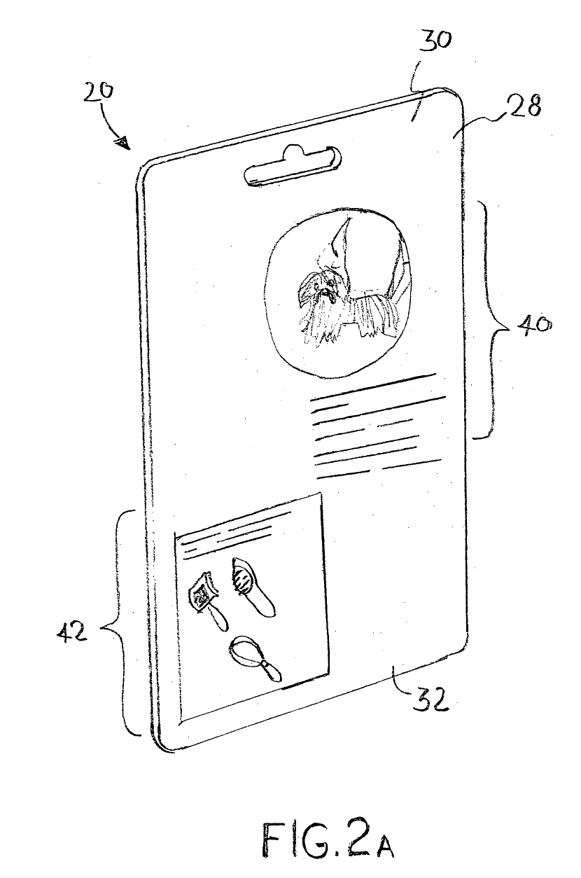

An instructional display 40, as seen in FIG. 2, that instructs the user on how to properly use the particular grooming tool 24, may also be present on the body 22 of the package 20, and in one example, may be present on the rear surface. The instructional display 40 can alternatively be shown on the front surface 26 or on both surfaces 26, 28 of the body 22. The instructional display 40 may be written text on how to properly use the particular grooming tool 24, may be one or-more diagrams or drawings showing how to properly use the particular grooming tool 24, or may be a combination thereof. More specifically, the instructional display 40 may be divided into several techniques or technique specific instructions. For example, the instructional display 40 may include instructions on how to use the tool with an under coat technique, on how to use the tool with an over coat technique, and/or on how to use the tool in hard-to-reach places on the animal. In this exemplary embodiment, the instructional display 40 includes both written text explaining how to properly use the slicker brush and pictures showing how the slicker brush is used.

An alternate tool display 42, as seen in FIG. 2, informing the user of what other tools may be used with the particular type of pet coat, may also be present on the body 22 of the package 20, and in one example, may be present on the rear surface 28. The alternate tool display 42 can optionally be shown on the front surface 26 or on both the front and rear surfaces 26, 28 of the body 22. The alternate tool display 42 may be written text listing what other tools may be used with the particular type of pet coat, may be one or more diagrams or drawings showing what other tools may be used with the particular type of pet coat, or may be a combination thereof. In this exemplary embodiment, the alternate tool display 42 includes both written text listing that a slicker brush, a short bristle brush, and/or a shedding blade may be used to groom an animal having a short single coat and pictures showing that a slicker brush, a short bristle brush, and/or a shedding blade may be used.

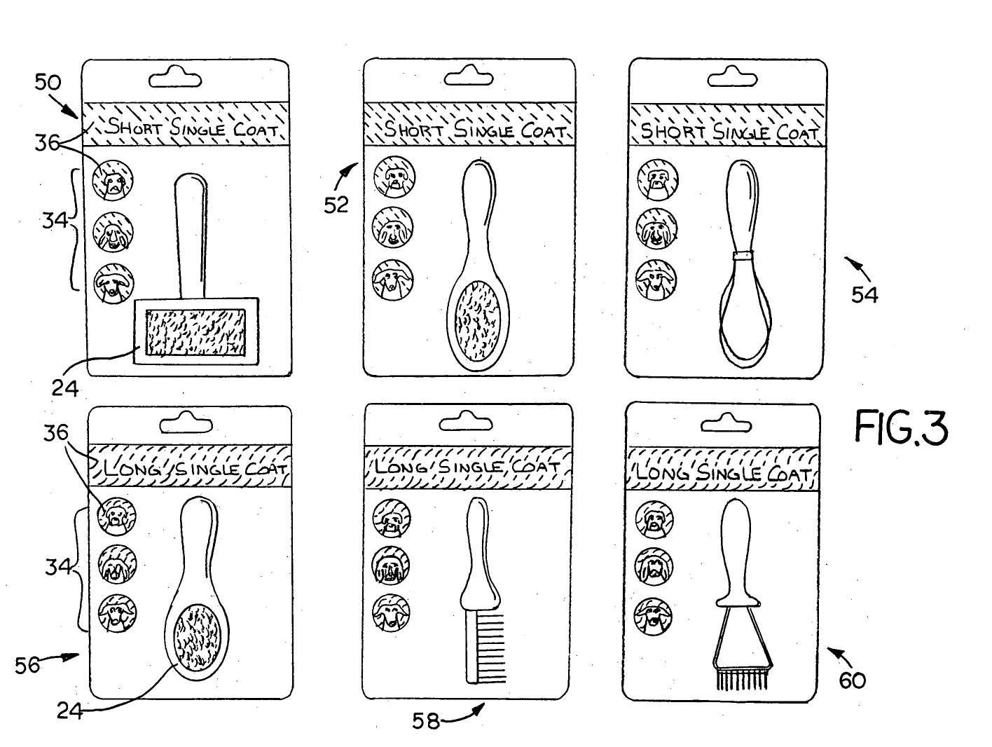

A plurality of packages 20, as described above, may be displayed together in combination to inform of optimal pet brushing criteria and aid the user or owner of a pet in choosing and using the proper tool(s) for their pet's type of coat. For example, as seen in FIG. 3, it may be easily determined by reviewing the various displayed packages 20 that one of the pet grooming tools 24 is optimal for a certain type of pet coat. More specifically, as the user reviews package 50, he or she can easily determine, by looking at the coat example 34 of the coat type, i.e. the picture of the Boxer, Beagle, and Weimaraner, that the pet grooming tool 24 (slicker brush) may be used for such animals, and for animals having the common pet coat type. Additionally, by observing the identifier 36 (the green colored bar and the green background to the coat example 34 of the pet coat type) and/or the name of the type of coat (short single coat), the user can easily identify the best tool, as well as other grooming tools 24 that are suitable for an animal with this type of pet coat, such as package 52 and 54.

Similarly, as the user reviews package 56, he or she can easily determine, by looking at the coat example 34 of the coat type, i.e. the picture of the Shih Tzu., Maltese, and Terrier, that the pet grooming tool 24 (pin brush) may be used for such animals, and for animals having their pet coat type. Additionally, by observing the identifier 36 (the blue colored bar and the blue background to the coat example 34 of the pet coat type) and/or the name of the type of coat (long single coat), the user can easily identify the best tool or other grooming tools 24 that are suitable for an animal with this type of pet coat, such as packages 58 and 60. It is apparent that by using the packaging and methods described above, a user can also easily identify which tools are not suitable for grooming their pet.

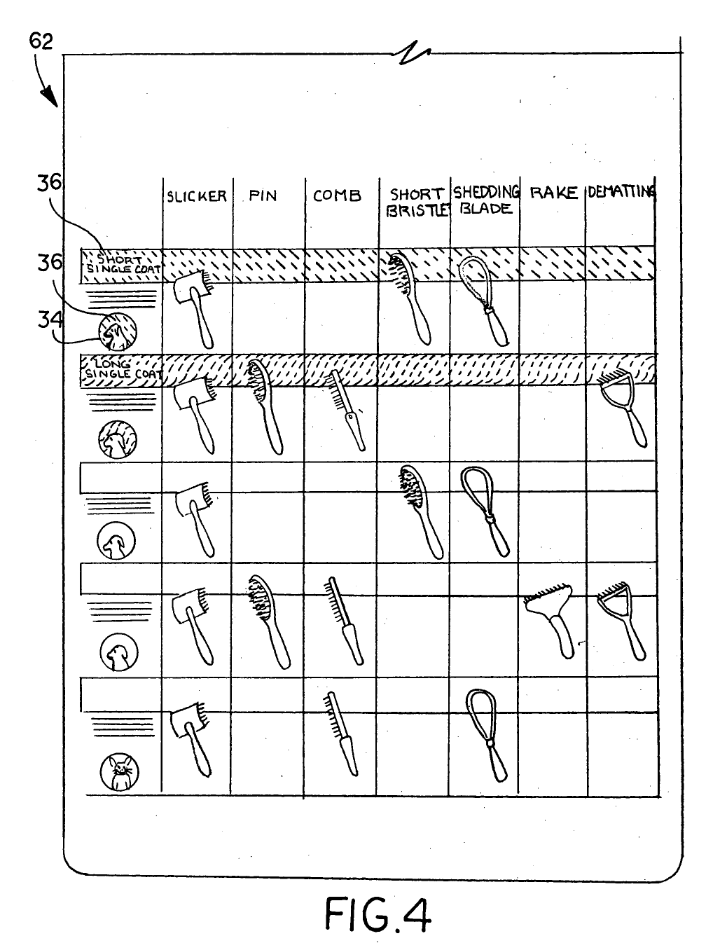

In another exemplary embodiment, a chart 62 can be created displaying a comprehensive overview of various pet coat types and corresponding grooming tools 24. More specifically, as seen in FIG. 4, the chart 62 may include the coat examples 34 of the pet coat type, and/or may include the names of the various types of pet coats. The chart 62 may also include the identifiers 36, each of which identifies a different type of pet coat. Once again, the identifiers 36 may be anything that identifies or is representative of the type of pet coat, and in this exemplary embodiment the identifiers 36 are colors that are assigned to the various types of pet coats.

Additionally, the chart 62 may include written text listing what other pet grooming tools 24 may be used with the particular type of pet coat, and/or include a drawing showing what other pet grooming tools 24 may be used with the various types of pet coats. As seen in FIG. 4, in this exemplary embodiment, the chart 62 includes drawings of the pet grooming tools 24 that may be used with the particular type of pet coat. The user can thus be informed of all available grooming tools and of the particular pet grooming tool 24 or tools that are optimal for use with their pet. The user can do so simply by determining the identifier 36 or name of the particular type of pet coat for their pet and selecting associated packages.

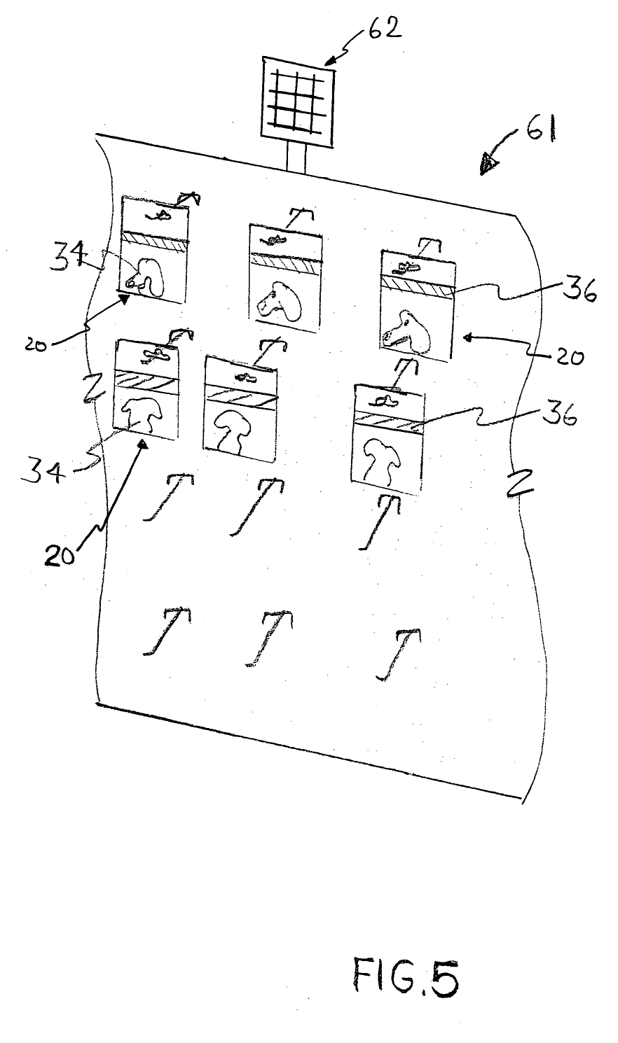

Given the previously mentioned and described pet grooming tools 24, pet coat examples 34, and identifiers 36, and other features, a method of informing of pet brushing criteria can be achieved. More specifically, by categorizing the various types of pet coats into categories such as short single coats, long single coats, short double coats, long double coats, long silky coats and cat coats, and by providing coat examples 34 of what types of animals have the various coat types, a user can easily determine the coat type of their pet. The various pet coat types may be assigned an identifier 36, such that each of the pet coat types may be discernable by recognizing the corresponding identifier 36. Devices, such as the grooming tool packages 20, a display rack 61 as shown in FIG. 5, and/or the charts 62, may then be coded with the appropriate identifier 36, thereby informing the user of the pet grooming tool 24 or tools that may be used for the particular pet coat type for their pet.

In operation, the method includes the step of providing packages 20 and corresponding plurality of grooming tools 24, each package having a particular grooming tool 24 carried thereon. The packages 20 are each marked with information relating to the specific tool type. Such information can include one or more of: a pet coat example 34 for which the grooming tool is suitable, an identifier 36 relating to the coat example, a benefit display 38 for the particular tool 24, an instructional display 40 for using the tool 24, and/or an alternate tool display 42 identifying other suitable tools 24 for the coat example 34 shown on the package 20.

The method next includes displaying the plurality of the packages 20 for access by a pet owner or user. The user must at some point determine the pet coat type of their pet and then the user views the plurality of the packages for information (i.e., coat example 34 and/or identifier 36) related to the coat type of their pet. The user can then select the one or more grooming tools suitable for their pet.

The method can also include the step of providing a chart 62 showing some or all of the information for each of the plurality of packages 20. The user can then identify the correct grooming tool 24 or tools for their pet simply by viewing the chart 62. Upon making the determination, the user can then select the correct package from the plurality of displayed packages 20 by using the coat examples 34 and/or the identifiers 36 on the various packages.

A system, as depicted in FIG. 5 can be provided for informing a user of the correct grooming tool or tools to use for their pet. The system can include providing a display rack 61 for displaying the packages 20 in a manner that renders each of the packages visible to the user. The system can also include information explaining the differences between the various packages to the user. The information, in one example, can be the chart 62 provided on or near the rack 61. The chart can cross reference the relationship between the package markings (i.e., the coat examples 34 and/or identifiers 36) and the corresponding grooming tools 24, such that a user can easily identify which tool or tools to select for their pet.

The methods, systems, packaging forms 20, charts 62, and various package marking options for informing of optimal pet brushing criteria as detailed below, can be utilized to aid the user or owner of a pet in choosing and using the proper tool(s) for their pet's type of coat. For example, the user may enter a pet store, an on-line virtual store, a department store, or the like, for purchasing one or more grooming tools 24 for their pet. The owner/user, however, usually does not know what type of grooming tool 24 is used with their pet's type of coat nor what coat type the pet has. As such, the user begins the purchasing process knowing only the animal breed, i.e. a Boxer, of their pet.

The user may begin the process of choosing the proper grooming tool 24 for the pet by viewing the various packages 20 or the chart 62, and more particularly, by viewing the coat examples 34 of the various types of pet coats. The user will be able to quickly determine what type of coat the pet has, by matching their pet to the coat examples 34 on the packages 20. More specifically, if their pet is a Boxer, the user must identify a Boxer on one of the plurality of displayed packages 20 by way of the coat example 34, or must identify another breed having a similar type of coat, such as a Beagle or Weimaraner. The user then, by further reading the package 20, will be able to determine the coat type of the pet, and in this example that their Boxer has a Single Short Coat.

Once the user knows what type of coat the pet has, the user may quickly determine the one or more grooming tools 24 that are designed or are optimal for use with a pet having that particular type of coat. More specifically, the user will notice that the coat type has a correlating identifier 36, such that the user will only have to look for the identifier 36 on the package 20 to determine which tool or tools are optimal for their pet's coat type. With an identifier present, the user will not have to examine each package 20 closely to determine which grooming tool or tools 24 are optimal. In this example, the identifier 36 is a (green) colorized bar prominently displayed on the package 20 suitable for a Boxer or Single Short Coat type. The user can simply look for packages 20 having the green colorized bar 36 to identify all grooming tools 24 that are suitable or optimal for the pet's coat type.

Once the user has determined the one or more grooming tools 24 that are suitable or optimal for the pet's particular type of coat, the user may further limit which of those grooming tools 24 to purchase by reviewing the packages 20 more closely. More specifically, the user may read and/or review the benefits display 38, when present on the package 20, to determine which of the suitable grooming tools 24 may be best suited for the user's pet. For example, the user may desire a grooming tool 24 to add shine to the pet's coat or desire a grooming tool to lift and remove loose hair from the top of the pet's coat. As such, the user may read the benefits display 38 to determine which of the suitable grooming tools 24 is best suited to fulfill the needs of the user. Once the user has chosen which grooming tool or tools 24 are suitable or optimal for the pet's type of coat and has determined which of those grooming tools 24 best fulfills the user's objective, the user may review and/or read the instructional display 40 to determine the proper method for utilizing the selected grooming tool 24.

While the above has been described with reference to specific examples which are intended to be illustrative only and not to be limiting of the invention, it will be apparent to those of ordinary skill in the art that changes, additions or deletions may be made to the disclosed embodiments without departing from the spirit and scope of the invention.

What is claimed is:

1. A method of informing of pet brushing criteria, comprising:
providing at least one example of a pet coat type on an object;
assigning an identifier to the pet coat type;
coding the object with the identifier; and
providing at least one pet grooming tool associated with the pet coat type and the identifier.

2. The method of informing of pet brushing criteria of claim 1, further including the step of naming the pet coat type.

3. The method of informing of pet brushing criteria of claim 1, further including providing instructions for using the pet grooming tool.

4. The method of informing of pet brushing criteria of claim 1, further including identifying different pet grooming tools associated with the pet coat type and the identifier.

5. The method of informing of pet brushing criteria of claim 1, wherein the step of providing the pet coat type further includes displaying at least one photograph of a pet with that pet coat type.

6. The method of informing of pet brushing criteria of claim 1, wherein the step of providing the pet coat type further includes providing at least one name of a breed having that pet coat type.

7. The method of informing of pet brushing criteria of claim 1, wherein the step of assigning an identifier includes assigning a color to the pet coat type.

8. A package having information relating to pet brushing criteria, comprising:
a body having a front side, a rear side, a top and a bottom;
a first display on the body corresponding to at least one example of a pet coat type;
a visual identifier on the body that corresponds to the pet coat type; and
a pet grooming tool carried by the package and being configured for grooming the pet coat type of the first display.

9. The package having information relating to pet brushing criteria of claim 8, further including a second display on the body providing instructions on how to use the pet grooming tool.

10. The package having information relating to pet brushing criteria of claim 8, further including a third display on the body identifying other pet grooming tools suitable for use with the pet coat type of the first display.

11. The package having information relating to pet brushing criteria of claim 8, wherein the first display of a pet coat type is a photograph of a pet with that pet coat type.

12. The package having information relating to pet brushing criteria of claim 8, wherein the first display of a pet coat type is disposed on the front side of the body.

13. The package having information relating to pet brushing criteria of claim 8, wherein the first display of a pet coat type is a name of a breed having that pet coat type.

14. The package having information relating to pet brushing criteria of claim 8, wherein the identifier is a color that corresponds to the pet coat type of the first display.

15. The package having information relating to pet brushing criteria of claim 8, wherein the identifier that corresponds to the pet coat type of the first display is disposed on the front side of the body.

16. The package having information relating to pet brushing criteria of claim 8, wherein the top of the body includes an aperture for hanging the package on a display rack.

17. The package having information relating to pet brushing criteria of claim 8, wherein the pet grooming tool is carried on the front side of the body.

18. A system for selecting a pet grooming tool, comprising:
a plurality of packages;
a plurality of different identifiers, at least one identifier being disposed on each package, wherein each package is associated with a different pet coat type;
a plurality of different pet grooming tools, at least one grooming tool being carried by each of the plurality of packages and configured for use in grooming the associated pet coat type of its respective package; and
a plurality of pet coat type examples, at least one pet coat type example being disposed on each package and corresponding to its respective pet coat type and its respective at least one identifier.

19. The system for selecting a grooming tool of claim 18, further including instructions disposed on each of the plurality of packages for instructing how to use the at least one grooming carried by the packages.

20. The system for selecting a grooming tool of claim 18, wherein the plurality of pet coat type examples includes at least one photograph of a pet with that pet coat type.

21. The system for selecting a grooming tool of claim 18, further comprising:
a display rack supporting the plurality of packages; and
a chart mounted in at least close proximity to the display rack and illustrating a relationship between each of the plurality of different grooming tools and each one or more related ones of the plurality of pet coat types.

22. A device for informing of pet brushing criteria, comprising:
a chart;
a plurality of pet coat types identified on the chart;
a plurality of pet breed examples identified on the chart, at least one pet breed example identified for each of the pet coat types;
a plurality of visual identifiers identified on the chart, at least one identifier shown for each of the pet coat types; and
a plurality of pet grooming tools identified on the chart, at least one pet grooming tool identified as relating to each identifier.

23. The chart for informing of pet brushing criteria of claim 22, wherein the plurality of pet coat types are disposed along a first axis of the chart, and wherein the plurality of visual identifiers are disposed along a second axis of the chart generally perpendicular to the first axis.

24. The chart for informing of pet brushing criteria of claim 22, wherein the plurality of pet coat types are shown along a first axis of the chart, and wherein the plurality of pet grooming tools are shown along a second axis of the chart generally perpendicular to the first axis.

25. The chart for informing of pet brushing criteria of claim 22, wherein the plurality of breed examples are depicted as photographs of different breeds each corresponding to a different one of the pet coat types.

26. The chart for informing of pet brushing criteria of claim 22, wherein the plurality of breed examples are depicted as names of different breeds each corresponding to a different one of the pet coat types.

27. The chart for informing of pet brushing criteria of claim 22, wherein the plurality of identifiers are depicted as different colors each corresponding to a different one of the pet coat types.

28. The chart for informing of pet brushing criteria of claim 22, wherein the plurality of pet grooming tools are depicted as photographs of different tools each corresponding to a different one of the plurality of identifiers.
